(19) United States
(12) Patent Application Publication
(10) Pub. No.: US 2015/0270716 A1
(43) Pub. Date: Sep. 24, 2015

(54) MULTI FREQUENCY POWER DRIVER FOR A WIRELESS POWER TRANSFER SYSTEM

(71) Applicant: KONINKLIJKE PHILIPS N.V., Eindhoven (NL)

(72) Inventor: Eberhard Waffenschmidt, Aachen (DE)

(21) Appl. No.: 14/432,863

(22) PCT Filed: Sep. 12, 2013
(86) PCT No.: PCT/IB2013/058478

§ 371 Date: Apr. 1, 2015

Related U.S. Application Data
(60) Provisional application No. 61/708,688, filed on Oct. 2, 2012.

(51) Int. Cl. H02J 5/00

(52) U.S. Cl. CPC H02J 5/005

(57) ABSTRACT

A wireless power transfer system comprises a plurality of receivers (310, 320, 330) operating at a different resonance frequency from each other, wherein each of the plurality of receivers includes at least a load (311, 321, 331); a driver (300) that generates a power signal that encompasses a plurality of driving signals (411, 412, 413) having different frequencies that substantially match the different resonance frequencies of the plurality of receivers; and a pair of transmitter electrodes (304, 305) connected to the driver and wirelessly coupled to each of the plurality of receivers, wherein the power signal generated by the driver is wirelessly transferred from the pair of transmitter electrodes to each of the plurality of receivers to power its respective load, wherein a load of a receiver of each of the plurality of receivers is powered when the frequency of one of plurality of driving signals substantially matches a resonance frequency of the receiver.

The invention generally relates to capacitive powering systems for wireless power transfers and, more particularly, to techniques for dynamically adjusting the resonant frequency of such systems.

A wireless power transfer refers to the supply of electrical power without any wires or contacts, whereby the powering of electronic devices is performed through a wireless medium. One popular application for wireless (contactless) powering is for the charging of portable electronic devices, e.g., mobiles phones, laptop computers, and the like.

One implementation for wireless power transfers is by an inductive powering system. In such a system, the electromagnetic inductance between a power source (transmitter) and the device (receiver) allows for wireless power transfers. Both the transmitter and receiver are fitted with electrical coils, and when brought into physical proximity, an electrical signal flows from the transmitter to the receiver.

In inductive powering systems, the generated magnetic field is concentrated within the coils. As a result, the power transfer to the receiver pick-up field is very concentrated in space. This phenomenon creates hot-spots in the system which limits the efficiency of the system. To improve the efficiency of the power transfer, a high quality factor for each coil is needed. To this end, the coil should be characterized with an optimal ratio of inductance to resistance, be composed of materials with low resistance, and fabricated using a Litze-wire process to reduce skin-effect. Moreover, the coils should be designed to meet complicated geometries to avoid Eddy-currents. Therefore, expensive coils are required for efficient inductive powering systems. A design for contactless power transfer system for large areas would necessitate many expensive coils. Thus, for such applications an inductive powering system may not be feasible.

Capacitive coupling is another technique for transferring power wirelessly. This technique is predominantly utilized in data transfer and sensing applications. A car-radio antenna glued on the window with a pick-up element inside the car is an example of a capacitive coupling. The capacitive coupling technique is also utilized for contactless charging of electronic devices. For such applications, the charging unit implementing the capacitive coupling operates at frequencies outside the inherent resonant frequency of the device.

In the related art, a capacitive power transfer circuit that enables LED lighting is also discussed. This circuit is based on an inductor in the power source (driver). As such, only a single receiver can be used and the transmitter should be tuned so as to transfer the maximum power. In addition, such a circuit requires pixelated electrodes that ensure power transfer from the receiver to the transmitter when they are not perfectly aligned. However, increasing the number of the pixelated electrodes increases the number of connections to the electrodes, thereby increasing the potential power losses. Thus, when having only a single receiver and limited size electrodes, the capacitive power transfer circuit discussed in the related art cannot supply power over a large area, e.g., windows, walls, and so on.

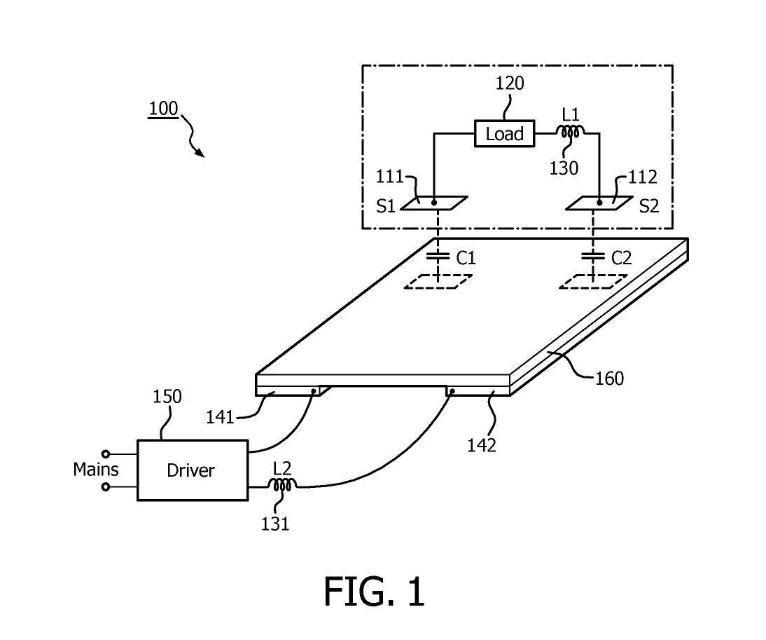

A capacitive power transfer system 100 that can be utilized to transfer power over large areas having a flat structure, e.g., windows, walls, and the like is depicted in FIG. 1. A typical arrangement of a system 100 includes a pair of receiver electrodes 111, 112 connected to a load 120 and an inductor 130. The system 100 also includes a pair of transmitter electrodes 141, 142 connected to a power driver 150, and an insulating layer 160.

The pair of transmitter electrodes 141, 142 is located on one side of the insulating layer 160, and the receiver electrodes 111, 112 are located on the other side of the insulating layer 160. This arrangement forms capacitive impedance between the pair of transmitter electrodes 141, 142 and the receiver electrodes 111, 112.

Power driver 150 generates a power signal that can be wirelessly transferred from the transmitter electrodes 141, 142 to the receiver electrodes 111, 112 to power the load 120. The efficiency of the wireless power transfer improves when a frequency of the power signal matches a series-resonance frequency of the system 100. The series-resonance frequency of the system 100 is a function of the inductive value of the inductor 130 and/or inductor 131, as well as the capacitive impedance between the pair of transmitter electrodes 141, 142 and the receiver electrodes 111, 112 (see C1 and C2 in FIG. 1). The capacitive impedance and the inductor(s) cancel each other out at the resonance frequency, resulting in a low-ohmic circuit. The load 120 may be, for example, a LED, a LED string, a lamp, a computer, loud speakers, and the like.

In the capacitive power transfer systems, the power signal is efficiently transferred when the frequency of the input AC power signal matches the resonant frequency at the receiver. For example, in the capacitive system that includes an inductive element, such as the system shown in FIG. 1, the resonant frequency of the inductor(s) and the capacitive impedance should substantially match the frequency of the AC power signal.

In certain configurations, the capacitive powering system includes multiple loads, each of which is connected in a different receiver. In such configurations, the power consumed by the different loads and the resonant frequencies of their respective receivers may be different from each other. As a result, the resonant frequency of each receiver may not be the same as the frequency of the respective power signal.

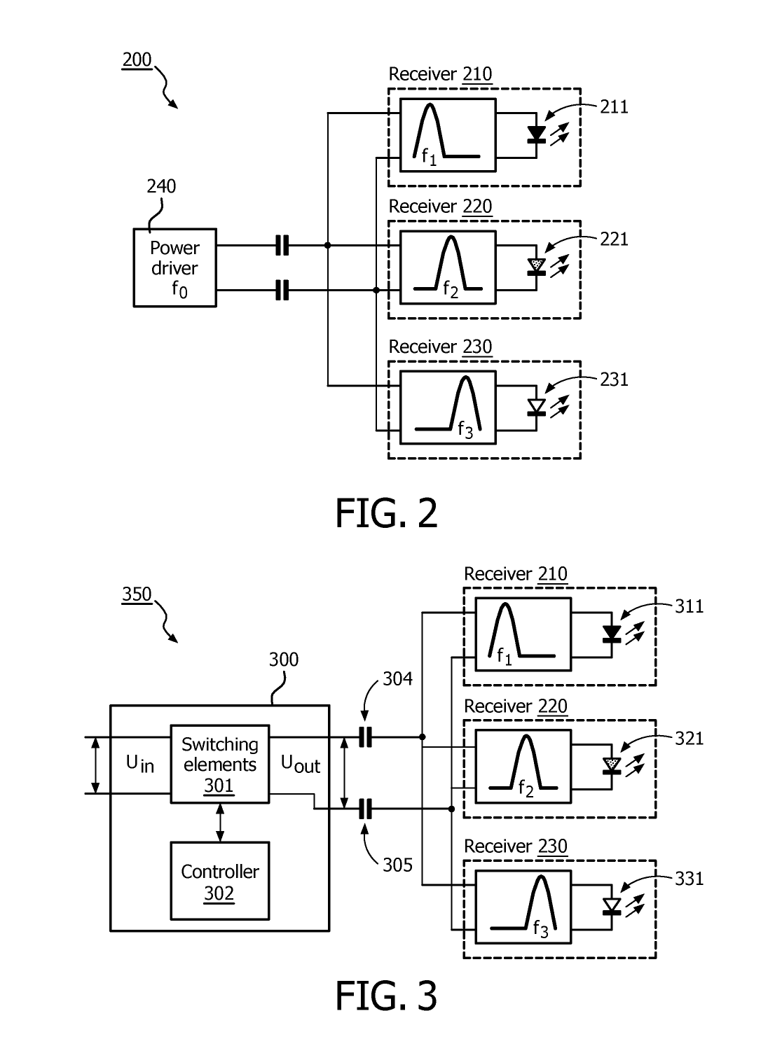

For example, FIG. 2 shows a schematic diagram of a capacitive power transfer system 200 that includes three receivers 210, 220, and 230 powered by a power driver 240. Each of the receivers 210, 220, and 230 includes a load 211, 221, and 231, respectively. The load in the exemplary FIG. 2 is illustrated as a LED. An AC power signal generated by the power driver 240 has an operating frequency f₀, and the resonant frequency (f₁, f₂, f₃) for each of the receivers 210, 220, and 230, is different. Thus, the operating frequency f₀ can be tuned to substantially match only one of frequencies f₁, f₂, or f₃. As a result, only one of the receivers operates optimally. In addition, trying to tune one receiver would affect the operation of the other receivers. Thus, a solution that can operate all the receivers in their optimal operation point and that will allow to control the receivers independently of each other is desired.

One solution to overcome this problem is to include a resonant frequency matching circuit in each of the receivers 210, 220, 230. Such a circuit changes the inductive or capacitive value of each receiver, thereby allowing for adjustment of the resonant frequency of the receiver. However, such a solution requires the inclusion of an additional circuit in each receiver and, therefore, increases the cost and complexity of the capacitive power transfer system.

Another solution may include changing the power signal frequency to meet the resonant frequency of each receiver. However, tuning f₀ to meet, for example, f₁ may result in taking the receiver 220 out of its resonance state. Thus, a solution is desired to match the resonant frequency of receivers independently of each other in a wireless power transfer system having a single power driver to ensure that each receiver optimally powers its respective load.

Certain embodiments disclosed herein include a wireless power transfer system. The system comprises a plurality of receivers operating at a different resonance frequency from each other, wherein each of the plurality of receivers includes at least a load; a driver that generates a power signal that encompasses a plurality of driving signals having different frequencies that substantially match the different resonance frequencies of the plurality of receivers; and a pair of transmitter electrodes connected to the driver and wirelessly coupled to each of the plurality of receivers, wherein the power signal generated by the driver is wirelessly transferred from the pair of transmitter electrodes to each of the plurality of receivers to power its respective load, wherein a load of a receiver of each of the plurality of receivers is powered when the frequency of one of plurality of driving signals substantially matches a resonance frequency of the receiver.

Certain embodiments disclosed herein also include a driver configured to independently drive a plurality of receivers operable in wireless power transfer system, wherein the plurality of receivers operating at a different resonance frequency from each other. The driver comprises a switching elements configured to output a power signal from an input signal based on at least one modulation schema, wherein the power signal encompasses a plurality of driving signals having different frequencies that substantially match the different resonance frequencies of the plurality of receivers; and a controller configured to control the switching elements by setting the at least one modulation scheme, the controller is further configured to determine the resonance frequency of each of the plurality of receivers.

Certain embodiments disclosed herein also include a method for generating a power signal to independently drive a plurality of receivers operable in a wireless power transfer system, wherein the plurality of receivers operating at a different resonance frequency from each other. The method comprises scanning a frequency band to determine the different resonance frequencies of the plurality of receivers; generating a modulation pulse pattern to modulate an input signal; modulating the input signal using the modulation pattern to generate a power signal, wherein the power signal encompasses a plurality of driving signals having different frequencies that substantially match the different resonance frequencies of the plurality of receivers.

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 is an illustration of a capacitive power transfer system that includes a single receiver.

FIG. 2 is an illustration of a wireless power transfer system that includes multiple receivers.

FIG. 3 is a diagram of a power driver utilized to generate a power signal to power a plurality of receivers connected in a wireless power transfer system according to one embodiment.

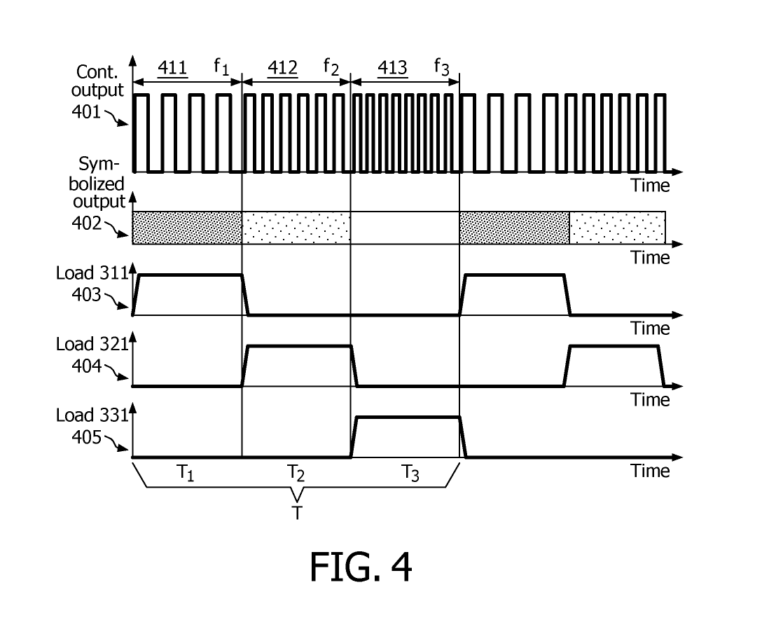

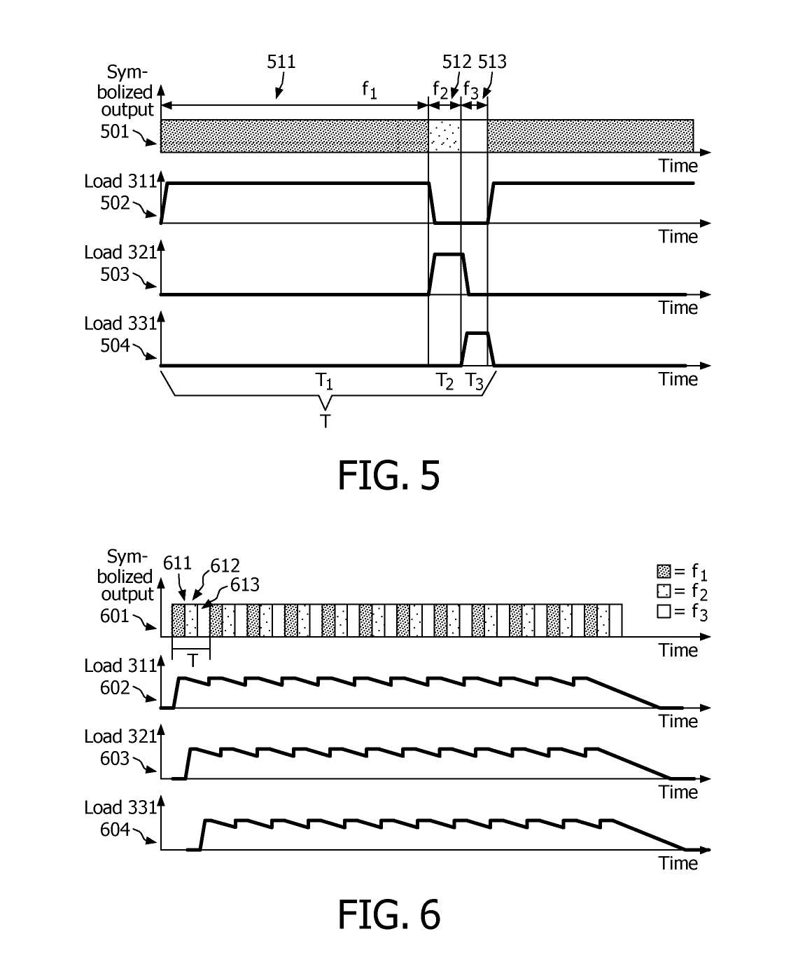

FIGS. 4 and 5 depict exemplary graphs illustrating a first modulation scheme utilized in generating a power signal according to one embodiment.

FIGS. 6, 7, and 8 depict exemplary graphs illustrating an interleaved modulation scheme utilized in generating a power signal according to another embodiment.

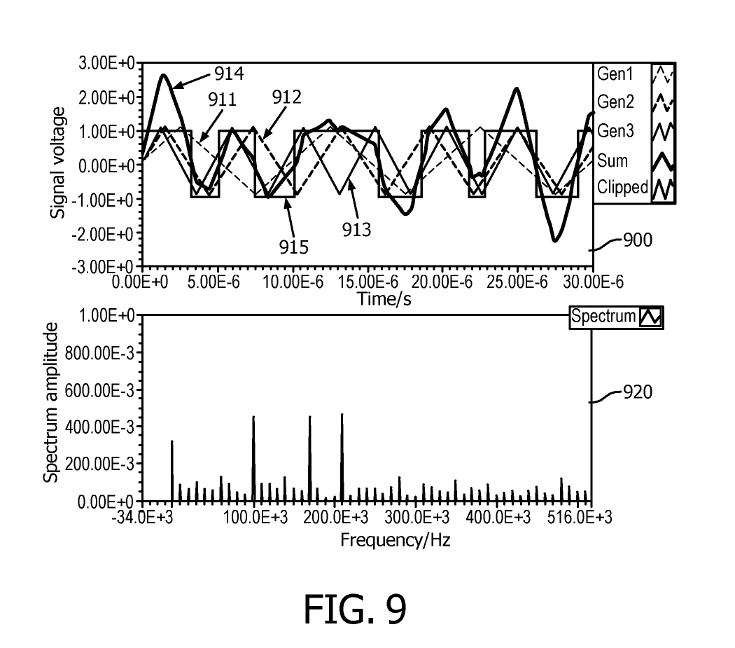

FIG. 9 depicts exemplary graphs illustrating the generation of a power signal that includes superimposed resonant frequencies according to another embodiment.

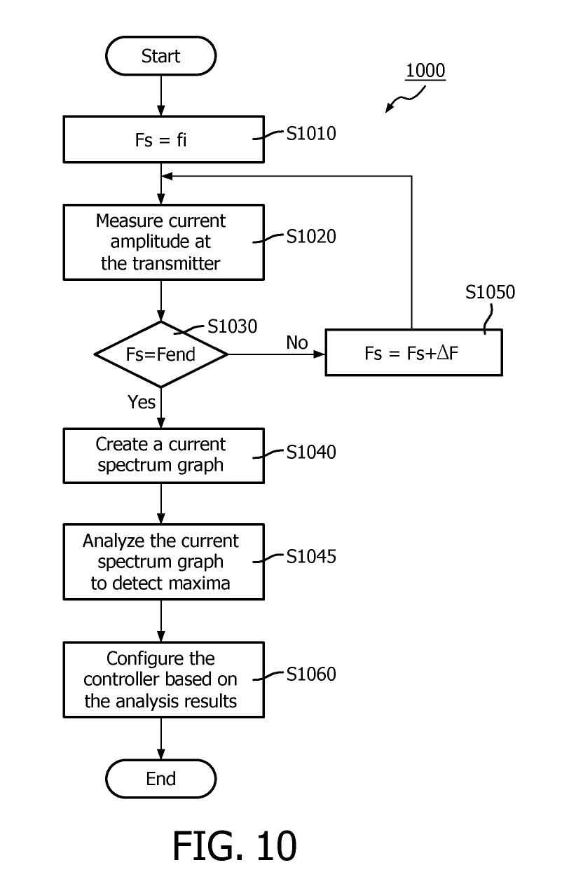

FIG. 10 is a flowchart illustrating a process for detecting receivers and their resonant frequencies in a wireless power transfer system according to one embodiment.

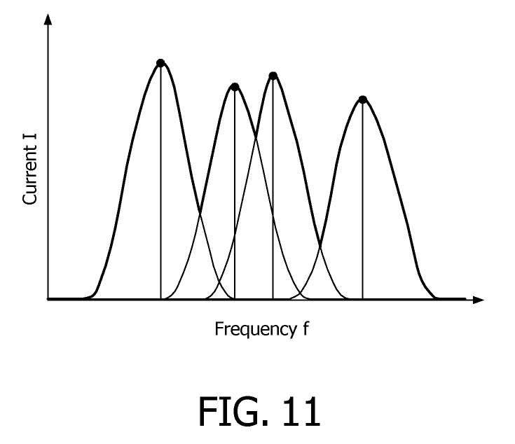

FIG. 11 is an exemplary current spectrum graph.

It is important to note that the embodiments are only examples of the many advantageous uses of the innovative teachings herein. In general, statements made in the specification of the present application do not necessarily limit any of the various claimed inventions. Moreover, some statements may apply to some inventive features, but not to others. In general, unless otherwise indicated, singular elements may be in plural and vice versa with no loss of generality. In the drawings, like numerals are intended to refer to like parts through several views.

According to the embodiments disclosed herein, to optimally power multiple loads connected in multiple receivers of a wireless power transfer system, a power driver generates a set of frequencies that matches the resonance frequencies of the receivers. The frequencies of which the power signal is comprised may be generated subsequent to each other, or alternatively may be superimposed on each other.

FIG. 3 shows an exemplary and non-limiting diagram of a power driver 300 utilized to generate a power signal to power a plurality of receivers connected in a wireless power transfer system 350. The wireless power transfer system 350 may be either an inductive or capacitive power transfer system.

Each of receivers 310, 320, and 330 illustrated in FIG. 3 operate at a different resonance frequency f₁, f₂, and f₃, respectively. Each of the receivers 310, 320, and 330 includes a load 311, 321, and 331, respectively. The load in the exemplary FIG. 3 is illustrated as a LED, however, it should noted that each load may be, for example, a LED string, a lamp, a computer, loud speakers, and the like. It should be further noted that although three receivers are shown in FIG. 3, the techniques disclosed herein can be utilized to drive any number of receivers, each of which may have a different resonance frequency. It should be further noted that each receiver 310, 320 and 330 operates in a different resonance frequency f₁, f₂, and f₃, and can represent a group of receivers. For example, the resonance frequency f₁ is the frequency of a group of (one or more) receivers that power red LED lamps, the resonance frequency f₂ is the frequency of a different group (one or more) receivers that power green LED lamps, and so on.

According to the embodiments disclosed herein, the power driver 300 generates a power signal that encompasses all the receivers resonance frequencies f₁, f₂, and f₃, thereby enabling optimal power transfer to each of the loads 311, 321, and 331. The power signal is transferred from the power driver to the receiver 310, 320, and 330 by means of the capacitive power coupling discussed in greater detail above with respect to FIG. 1. In another embodiment, such a power transfer can be performed by means of inductive coupling when the wireless power transfer system 350 is configured as an inductive power transfer system.

The power driver 300, in one embodiment, includes switching elements 301, such as in a configuration of a half-bridge driver. The switching elements 301 are controlled by a controller 302. The input of the driver 300 is an input signal Uᵢₙ (which may be a DC signal) generated by a power source (not shown) and outputs of the driver 300 are coupled to transmitter electrodes 304, 305 of the wireless power transfer system 350. In an embodiment of the invention, the output power signal Uₒᵤₜ encompasses the resonant frequencies f₁, f₂, and f₃. As noted above, in the Uₒᵤₜ signal the frequencies f₁, f₂, and f₃ may be subsequent to each other or superimposed on each other. The controller 302 may be implemented as a processor, a microprocessor, a programmable signal processor, and the like.

The controller 302 generates a plurality of different driving signals that modulate the input signal Uᵢₙ, such that the signal Uₒᵤₜ includes the frequencies f₁, f₂, and f₃. In one embodiment, the driving signals output by the controller 302 are frequency shift keying (FSK) pulse patterns. The FSK is a frequency modulation technique in which data streams are transmitted through discrete frequency changes of a carrier signal. The FSK pulses are related to the appearance of frequencies in the data streams. However, according to the embodiments disclosed herein, the FSK patterns are utilized to modulate the Uᵢₙ signal, such that the modulated signal (Uₒᵤₜ) will carry all the resonance frequencies of the receivers in the wireless power transfer system.

FIG. 4 illustrates a first modulation scheme according to one embodiment. The controller's 302 output, represented by a graph 401, includes driving signals 411, 412, and 413 having the frequencies f₁, f₂, and f₃which correspond to the receivers' 310, 320, and 330 resonant frequencies' f₁, f₂, and f₃. As represented by graphs 402 and 403, for the duration (T1) the load 311 is powered, because the generated output power signal contains the driving signal 411 with the frequency f₁. The frequency f₁ corresponds to the resonant frequency f₁ of the receiver 310. Graph 402 represents a symbolized output of the power driver 300. For the duration (T2) the load 321 is powered (see graphs 402 and 404), as the generated output power signal contains a driving signal 412 with the frequency f₂. This frequency corresponds to the resonant frequency f₂ of the receiver 320. In a similar fashion, for the duration (T3) the load 331 is powered (see graphs 402 and 405), as the generated output power signal includes a driving signal 413 with the frequency f₃ which corresponds to the resonant frequency of the receiver 330.

In the embodiment illustrated in FIG. 4, each of the signals 411, 412, and 413 is repeated every “repetition cycle” T which is the sum of T1, T2 and T3. By configuring each of the time durations T1, T2 and T3 to be equal to each other, the resonant time for each receiver is equal. Thus, all loads 311, 321, and 331 will be powered by same power. Therefore, by controlling the time duration of each driving signal (e.g., signals 411, 412, and 413), the distribution of the power transferred from the transmitter to the receivers in the wireless power transfer system can be controlled.

For example, as shown in FIG. 5, in graph 501 which represents a symbolized output of the power driver 300, the duration of the driving signal 511 is much longer than the durations of the driving signals 512 and 513. The driving signals 511, 512, and 513 have the frequencies f₁, f₂, and f₃which correspond to the resonant frequencies f₁, f₂, and f₃ of receivers 310, 320, and 330. Thus, according to the modulation scheme shown in FIG. 5, the load 311 is powered for a longer duration of time relative to the loads 321 and 331, as depicted in graphs 502, 503, and 504.

According to one embodiment, the frequencies of the driving signals are significantly higher than the repetition rate corresponding to the repetition cycle. For example, each of the frequencies f₁, f₂, and f₃ of the driving signals (e.g., signals 411, 412, and 413) is significantly higher than the repetition rate 1/T, where T is the duration of the repetition cycle. In a particular embodiment, when the load is an illuminated element (e.g., a LED) the repetition rate is high enough to be invisible to the human eye. As an example, the frequencies f₁, f₂, and f₃ may be 460 kHz, 380 kHz, and 320 kHz, respectively, while the repetition rate is 100 Hz.

FIG. 6 shows an exemplary diagram illustrating an interleaved modulation scheme utilized in the generation of the output power signal Uₒᵤₜ according to another embodiment. The modulation scheme allows for receivers 310, 320, 330 to be powered on to their maximum level simultaneously. According to this embodiment, as shown in graph 601, representing a symbolized output of the driver 300, the driving signals 611, 612, 613 are short intermediate pulses alternating between the receivers 310, 320, and 330. The signals 611, 612, and 613 have the frequencies f₁, f₂, and f₃ which correspond to the resonant frequencies f₁, f₂, and f₃ of receivers 310, 320, and 330. The repetition rate (1/T) is determined by the repetition cycle (T) of the three consecutive driving signals 611, 612, and 613. The repetition rate is higher than the corner frequency of the low pass filter in the receiver. For example, if the resonant frequencies f₁, f₂, and f₃ are 460 kHz, 380 kHz, and 320 kHz, respectively, the repetition rate may be, e.g., 10 kHz or 100 Hz. The corner frequency of the low pass filter in this case can be selected to be 1 kHz. Typically, a receiver includes a rectifier and an electrolytic capacitor (elcap) being utilized to “smooth” the voltage ripple. The diodes, the elcap, and the load form a low pass filter. The low pass filter has a certain corner frequency (or edge frequency), whereby below this frequency signal can pass, especially DC signals. Frequencies that are higher than the corner frequency, e.g., the voltage signal ripples, are blocked.

It should be noted that by setting the repetition rate as defined above, the repeated driving signals received at each receiver are smoothed to a constant voltage. This is further illustrated in graphs 602, 603, and 604 which show that the power level of the loads 311, 321, and 331 is at its maximum level for the duration of the output signal. It should be noted that the small ripples in the signals illustrated in graphs 602, 603, and 604 are merely for illustration purposes to indicate the transitions between driving signals 611, 612, and 613. As noted above, the power level at each load is constant.

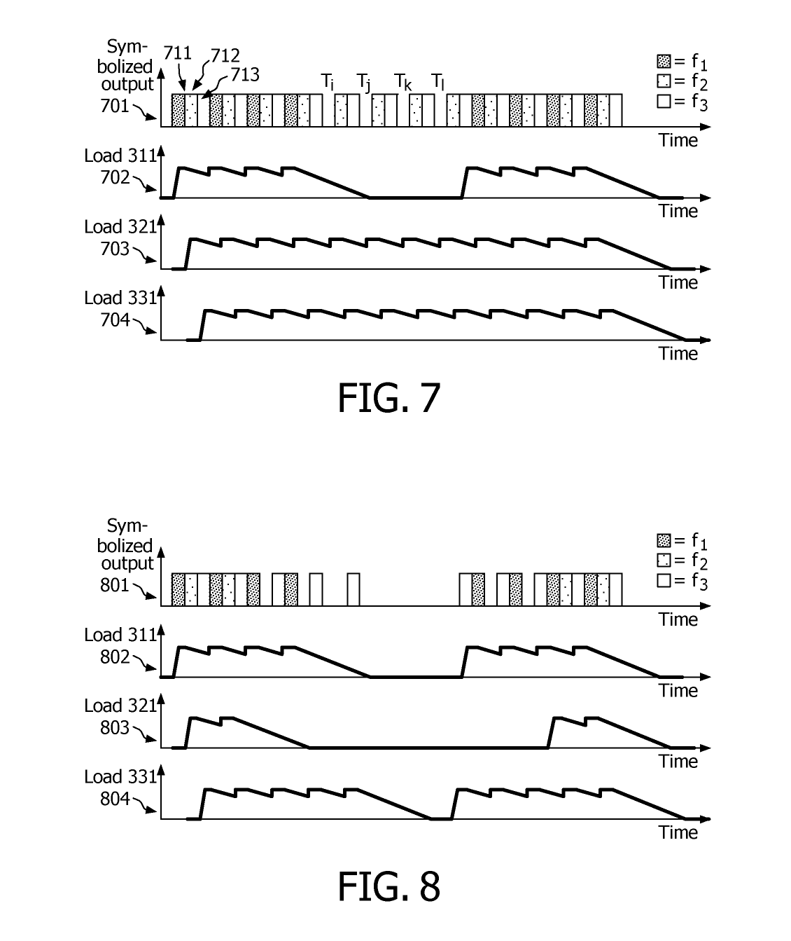

In one embodiment, the interleaved modulation scheme illustrated in FIG. 6 can be modified to independently adjust the power level at each load. This can be performed by omitting some of the driving signals (i.e., intermediate pulses) of the respective receiver that should be power controlled. For example, as shown in FIG. 7, in a symbolized output of the driver 300 represented by graph 701, driving signals 711 respective of the receiver 310 are not transmitted during Tᵢ, Tⱼ, Tₖ, and Tₗ. Thus, during these time intervals, the power level at the load 311 is reduced with respect to loads 321 and 331 (see graphs 702, 703, and 704).

In this embodiment, driving signals 711, 712, 713 are short intermediate pulses alternating between the receivers 310, 320, and 330. The signals 711, 712, and 713 have the frequencies f₁, f₂, and f₃which correspond to the resonant frequencies f₁, f₂, and f₃ of receivers 310, 320, and 330. The repetition rate of the three consecutive driving signals 711, 712, and 713 is higher than the corner frequency of the low-pass filter of the receiver.

It should be noted that the power level received at all of the receivers can be controlled according the principles of the interleaved modulation scheme illustrated in FIG. 7. For example, FIG. 8 depicts an interleaved modulation scheme where the power level received at all loads 311, 321, and 331 is adjusted to different power levels (see graphs 802, 803 and 804). As seen in graph 801, this can be achieved by changing the occurrences of the driving signals of the receivers 310, 320, and 330.

To allow the proper generation of the power signal Uₒᵤₜ, output by the power driver 300, the controller 302 should be configured with the resonant frequencies f₁, f₂, and f₃ of receivers 310, 320, and 330. This is applied in order to generate the driving signals at the resonant frequencies and may be applied to any of the modulation schemes discussed above.

In another embodiment disclosed herein, the power signal Uₒᵤₜ generated by the power driver 300 may be superimposed on signals respective of the resonant frequencies f₁, f₂, and f₃. Accordingly, a pulse stream that contains a frequency mixture of the resonant frequencies is generated. As an example, three receivers are connected, which have different resonant frequencies f₁, f₂, and f₃. The controller 302 generates three signals having the same amplitude with the frequencies f₁, f₂, and f₃ related to the resonant frequencies f₁, f₂, and f₃.

The waveform of each of the three signals generated by the controller 302 is preferably symmetric and may be, e.g., sinusoidal or triangular. In the exemplary embodiment illustrated in FIG. 9, the signals 911, 912, and 913 have triangular waveform. The controller 302 adds the instantaneous values on each curve of the signals 911, 912, and 913 for each point in time to create a new signal, illustrated as signal 914 in graph 900. The new signal is a superimposed pattern of the generated signals 911, 912, and 913. The new signal 914 is clipped such that the sign of the signal is taken. For example, the clipped signal is shown as signal 915 in graph 900. The clipped signal 915 is input to the switching elements 301. The clipped signal 915 contains the basic frequencies of which the signals are composed.

A graph 920 shows the fast Fourier transformation (FFT) of a clipped signal 915, which illustrates the spectral content of the signal. The frequencies f₁=100 kHz, f₂=170 kHz, and f₃=210 kHz are clearly shown in the graph 920. In this example, the frequencies f₁=100 kHz, f₂=170 kHz, and f3=210 kHz are related to the resonant frequencies f₁, f₂, and f₃ of three receivers.

According to one embodiment, during an initialization process of the wireless power transfer system, a process for detecting the number of receivers and their respective resonant frequencies is performed. FIG. 10 shows an exemplary and non-limiting flowchart 1000 illustrating the operation of the detection process.

The process is triggered when the system is powered on or based on a user command. At S1010, a scanning frequency Fs of the controller (e.g., controller 302) is set for an initial frequency fᵢ. At S1020, the current amplitude at the transmitter is measured at the scanning frequency Fs, and then recorded. The current amplitude can be measured by means of a current probe, a shunt, and the like.

At S1030, it is checked if the scanning frequency Fs equals to F_{end} which indicates the end of the frequency to be scanned, and if so, execution continues with S1040. Otherwise, at S1050 the current scanning frequency Fs is increased by a predefined frequency value (Δf). Then, execution returns to S1020.

The execution reaches S1040 when the entire frequency spectrum at which resonant frequencies can exist has been scanned, and the current amplitude at each scanning point has been measured and recorded. At S1040, a current spectrum graph using the measured current amplitude is generated. An exemplary current spectrum graph is shown in FIG. 11. At S1045, the current spectrum graph is analyzed to find a number of maxima that appear in the graph. For each maxima its respective frequency is also detected. The number of maxima in the current spectrum graph is the same as the number of receivers in a wireless power transfer system. The frequencies of the maxima are the resonant frequencies of the receivers. For example, as shown in FIG. 11, the number of maxima is 4, whereby 4 receivers are detected. At S1060, the controller (e.g., controller 302) is configured with the number of detected receivers and their corresponding resonant frequencies.

In another embodiment, the receivers in a wireless power transfer system communicate with the controller. The controller can distinguish the communications from different receivers. Each receiver measures a power level, at a frequency scanning point set by the transmitter, and communicates the measured power levels to the controller. Based on the measured power, the controller detects the resonant frequency of each receiver. The maximum power level of a receiver is typically measured at the resonant frequency of the receiver.

In one embodiment, once the controller is set with the resonant frequencies it can generate the driving signals as discussed in greater detail above, while these frequencies are kept fixed during operation of the system.

In another embodiment, the controller continuously adjusts the frequencies of the driving signals during the operation of this system. With this aim, the controller measures the current of the transmitter and filters the measured current with a band-pass filter. The center frequency of the band-pass filter can be varied and is set to one of the frequencies. The band-pass filter may be a digital filter. Then, the controller changes the frequency of each of the driving signals respective of one receiver, and the band-pass filter frequency, by a predefined value. If the output power increases in one direction due to the variation, the frequency is varied further in this direction, until the power, measured by the current amplitude, decreases again. At this point, the maximum power point is found. This process is repeated for all receivers.

Alternatively, each receiver measures the receiver power and sends the measured value via a separate data communication channel (not shown) to the controller. The controller uses the measured values to detect the maximum power point for each receiver.

The various embodiments disclosed herein can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A wireless power transfer system comprising:
a plurality of receivers operating at a different resonance frequency from each other, wherein each of the plurality of receivers includes at least a load;
a driver that generates a power signal that encompassed a plurality of driving signals having different frequencies that substantially match the different resonance frequencies of the plurality of receivers; and
a pair of transmitter electrodes connected to the driver and wirelessly coupled to each of the plurality of receivers, wherein the power signal generated by the driver is wirelessly transferred from the pair of transmitter electrodes to each of the plurality of receivers to power its respective load, wherein a load of a receiver of each of the plurality of receivers is powered when the frequency of one of plurality of driving signals substantially matches a resonance frequency of the receiver;
wherein the generated power signal is configured to independently control at least one of:
a duration that each of the loads in the plurality of receivers is powered on, and a power level at each of the loads, and the driver further includes:
a switching element configured to output the power signal from an input signal based on at least one modulation schema; and
a controller configured to control the switching element by setting the at least one modulation scheme.

2. The wireless power transfer system of claim 1, wherein the wireless power transfer system is any one of: a capacitive power transfer system and an inductive power transfer system, wherein the pair of transmitter electrodes of the inductive power transfer system includes inductive coils coupled to the driver.

3. The wireless power transfer system of claim 2, wherein each of the plurality of receivers includes a group of receivers having the same resonance frequency.

4. (canceled)

5. (canceled)

6. The wireless power transfer system of claim 1, wherein the controller is further configured to determine the resonance frequency of each of the plurality of receivers.

7. The wireless power transfer system of claim 1, wherein the at least one modulation scheme causes the driver to generate the plurality of driving signals as sequential driving signals.

8. The wireless power transfer system of claim 1, wherein the at least one modulation scheme can be configured to independently adjust at least a duration, a repetition cycle, and a power level of each of the sequential driving signals, wherein the frequencies of the plurality of the sequential driving signals are higher than a frequency of the repetition cycle.

9. The wireless power transfer system of claim 1, wherein the plurality of sequential driving signals are generated using an interleaved modulation scheme, enabling the loads of the plurality of receivers to be powered on to their maximum level simultaneously.

10. The wireless power transfer system of claim 9, wherein the at least one modulation scheme includes an interleaved modulation scheme modified to omit one or more of the plurality of sequential driving signals, whereby a power level of each of the loads is adjusted independently.

11. The wireless power transfer system of claim 1, wherein the plurality of driving signals are simultaneously generated and superimposed onto each other.

12. A driver configured to independently drive a plurality of receivers operable in wireless power transfer system, wherein the plurality of receivers operate at a different resonance frequency from each other, the driver comprises:
a switching element configured to output a power signal from an input signal based on at least one modulation schema, wherein the power signal encompasses a plurality of driving signals having different frequencies that substantially match the different resonance frequencies of the plurality of receivers; and
a controller configured to control the switching element by setting the at least one modulation scheme, the controller is further configured to determine the resonance frequency of each of the plurality of receivers.

13. The driver of claim 12, wherein the at least one modulation scheme causes to generate the plurality of driving signals as sequential driving signals.

14. The driver of claim 11, wherein the plurality of driving signals are simultaneously generated and superimposed onto each other.

15. A method for generating a power signal to independently drive a plurality of receivers operable in a wireless power transfer system, wherein the plurality of receivers operate at a different resonance frequency from each other, comprising:
scanning a frequency band to determine the different resonance frequencies of the plurality of receivers;
generating a modulation pulse pattern to modulate an input signal;
modulating the input signal using the modulation pattern to generate a power signal, wherein the power signal encompasses a plurality of driving signals having different frequencies that substantially match the different resonance frequencies of the plurality of receivers.
